(19) United States
(12) Patent Application Publication
(10) Pub. No.: US 2011/0087611 A1
(43) Pub. Date: Apr. 14, 2011

(54) BIOMETRIC IDENTIFICATION AND AUTHENTICATION SYSTEM FOR FINANCIAL ACCOUNTS

(76) Inventor: Shyam Chetal, Fremont, CA (US)

(21) Appl. No.: 12/752,178

(22) Filed: Apr. 1, 2010

Related U.S. Application Data
(60) Provisional application No. 61/251,304, filed on Oct. 14, 2009.

(51) Int. Cl. G06Q 40/00; G06Q 10/00; G06K 9/00; G10L 17/00

(52) U.S. Cl. 705/325; 382/118; 704/246

(57) ABSTRACT

A method and an apparatus of biometric identification and authentication for financial transaction are disclosed. In one aspect, an automated teller machine is provided to assist a user to make a financial transaction. A linguistic command data is processed to create an account of the user. The user is directed to place a finger on a fingerprint scanner and the fingerprint is imaged. The user is directed to place an iris of in front of an iris scanner, and/or to place a face of the user in front of a camera to collect biometric data of the user. A name and address of the user is correlated to identify the account of the user. The face, fingerprint and/or iris of the user is imaged and compared to the biometric data to verify identify. An access to the account is provided on verifying the identity of the user.

### CLAIM OF PRIORITY

This Application is a Utility Application and claims priority from a U.S. Provisional Application No. 61/251,304 titled: “BIOMETRIC IDENTIFICATION AND AUTHENTICATION SYSTEM FOR FINANCIAL ACCOUNTS” filed on Oct. 14, 2009.

### FIELD OF TECHNOLOGY

This disclosure relates generally to the technical field of financial management and software and, in one embodiment, to a method, system and an apparatus of biometric identification and authentication system for financial accounts.

### BACKGROUND

An automated teller machine (ATM) may be a device that is used for performing transactions (e.g., deposit, withdrawal, account balance check). A user of the ATM may have to carry a card to the ATM that that enables the ATM to identify the user. In addition, the user may have to provide a secret Personal Identification Number (PIN) via a user interface to gain access to a personal account through the ATM. The user may not be able to access the account if the PIN is wrong or if the user forgets the PIN. However, if the user forgets to carry the card or if the user loses the card, the user may be unable to gain access to the user account to perform transactions through the ATM. As a result, the user may have to spend more time to perform transactions in a bank.

An illiterate person may have difficulty using the ATM or banking services. Even if the illiterate person has an account in a bank, the illiterate person may not be able to operate the account through an ATM. Therefore, the ATM may not be utilized by a particular section of users (e.g. illiterate users). As a result, the work load of the bank may increase as ATMs may not be utilized sufficiently.

### SUMMARY

A method and system of biometric identification and authentication system for financial accounts are disclosed. In one aspect, a method of biometric identification includes providing an automated teller machine to assist a user to make a financial transaction, processing a linguistic command data, determining that the linguistic command data is associated with a set of instructions of the automated teller machine, and identifying a particular instruction of the set of instructions of the automated teller machine through the linguistic command data. The method also includes processing the linguistic command data to create an account of the user, identifying the set of instructions to create the account of the user and directing the user with a first instruction in a native language of the user to provide a name of the user to create the account of the user.

In addition, the method includes recording the name of the user to create the account of the user, directing the user with a second instruction in the native language of the user to provide an address of the user to create the account of the user, recording the address of the user to create the account of the user and correlating the name and the address of the user to identify the account of the user. The method further includes directing the user with a third instruction in the native language of the user to place a finger of the user on a fingerprint scanner to establish the account of the user, imaging a fingerprint of the user to produce a first fingerprint image to collect biometric data of the user, converting the first fingerprint image into a first digital fingerprint image, and storing the first digital fingerprint image in a fingerprint database.

The method also includes directing the user with a fourth instruction in the native language of the user to place an iris of the user in front of an iris scanner to establish the account of the user, imaging the iris of the user to produce a first iris image to collect biometric data of the user, converting the first iris image into a first digital iris image, and storing the first digital iris image in an iris database. The method further includes directing the user with a fifth instruction in the native language of the user to place a face of the user in front of a camera to establish the account of the user, imaging the face of the user to produce a first face image to collect biometric data of the user, converting the first face image into a first digital face image, and storing the first digital face image in a face database. In addition, the method includes correlating the first digital fingerprint image, the first digital iris image, and the first digital face image to the account of the user. The method further includes processing the linguistic command data to access the account of the user. The method also includes identifying the set of instructions to access the account of the user.

In addition, the method includes directing the user with the third instruction in the native language of the user to place the finger of the user on the fingerprint scanner to access the account of the user. The method also includes imaging the fingerprint of the user to produce a second fingerprint image to identify biometric data of the user, converting the second fingerprint image into a second digital fingerprint image, and comparing the second digital fingerprint image to a fingerprint template of the fingerprint database. The fingerprint template includes one or more digital fingerprint image. In addition, the fingerprint characteristic includes a ridge location of the fingerprint. The method further includes comparing the second digital fingerprint image to the first digital fingerprint image based on the fingerprint characteristic, and determining the second digital fingerprint and the first digital fingerprint are the same to identify the user.

In addition, the method includes directing the user with fourth instruction in the native language of the user to place the iris of the user in front of the iris scanner to access the account of the user, imaging the iris of the user to produce a second iris image to identify biometric data of the user, converting the second iris image into a second digital iris image, comparing the second digital iris image to a iris template of the iris database. The iris template includes one or more digital iris image, based on an iris characteristic. In addition, the iris characteristic includes a pigmentation of the iris.

The method includes comparing the second digital iris image to the first digital iris image based on the iris characteristic, and determining the second digital iris image and the first digital iris image are the same to identify the user. The method also includes directing the user with the fifth instruction in the native language of the user to place the face of the user in front of the camera to access the account of the user, imaging the face of the user to produce a second face image to identify biometric data of the user, converting the second face image into a second digital face image and comparing the second digital face image to a face template of the face database. The face template includes one or more digital face images, based on a face characteristic. The face characteristic includes a nose location.

The method further includes comparing the second digital face image to the first digital face image based on the face characteristic, determining the second digital face image and the first digital face image are the same to identify the user and providing access to the account after determining that the second digital fingerprint image and the first digital fingerprint image are the same and/or the second digital iris image and the first digital iris image are the same, and/or the second digital face image and the first digital face image are the same to increase a confidence of an identification of the user.

The method further includes accepting a monetary currency though a fund acceptor connected to the automated teller machine to increase an account balance of the account. In addition, the method includes providing a first verbal statement through a speaker to inform the user of an amount deposited and the account balance to assist the user that is illiterate. The method also includes dispensing a monetary currency though a fund dispenser connected to the automated teller machine to decrease the account balance of the account. In addition, the method further includes providing a second verbal statement through the speaker to inform the user of an amount withdrawn and the account balance to assist the user that is illiterate.

In addition, the method may include requesting a secondary authentication of the user when a biometric pattern and/or a voice pattern is unrecognizable. The method may also include notifying a human service personnel associated with the automated teller machine and/or a banking system to manually authenticate the user when the biometric pattern and/or the voice pattern are unrecognizable. The method may further include authenticating a user of a banking system accessible through the automated teller machine by analyzing a biometric pattern and/or a voice pattern uniquely associated with the user. In addition, the method may include providing access to a financial account of the banking system associated with the user based on the authentication. In addition, the method may include identifying the set of instructions to authenticate the account of the user create the account of the user with a personal identification number when a biometric pattern and/or a voice pattern is unrecognizable. The method may also include directing the user with a sixth instruction in the native language of the user to provide the personal identification number to authenticate the account of the user. The method may further include recording the personal identification number to authenticate the account of the user and providing access to the financial account of the banking system associated with the user based on the authentication.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE VIEWS OF DRAWINGS

Example embodiments are illustrated by way of example and not a limitation in the figures of accompanying drawings, in which like references indicate similar elements and in which:

FIG. 1 illustrates a system of biometric identification and authentication for financial transaction, in accordance with one or more embodiments;

FIG. 2 is a system view illustrating implementation details of a biometric system, in accordance with one or more embodiments.

FIG. 3 is a perspective view of an automated teller machine, in accordance with an example embodiment;

FIG. 4 illustrates a schematic view of a user using an automated teller machine enabled with a biometric identification unit for a financial transaction, in accordance with to one or more embodiments; and

FIGS. 5A-5F is a process flow illustrating a method of biometric identification and authentication for financial transaction, in accordance with one or more embodiments.

Other features of the present embodiments will be apparent from accompanying Drawings and from the Detailed Description that follows.

### DETAILED DESCRIPTION

A method and a system of biometric identification and authentication system for financial transaction are disclosed. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

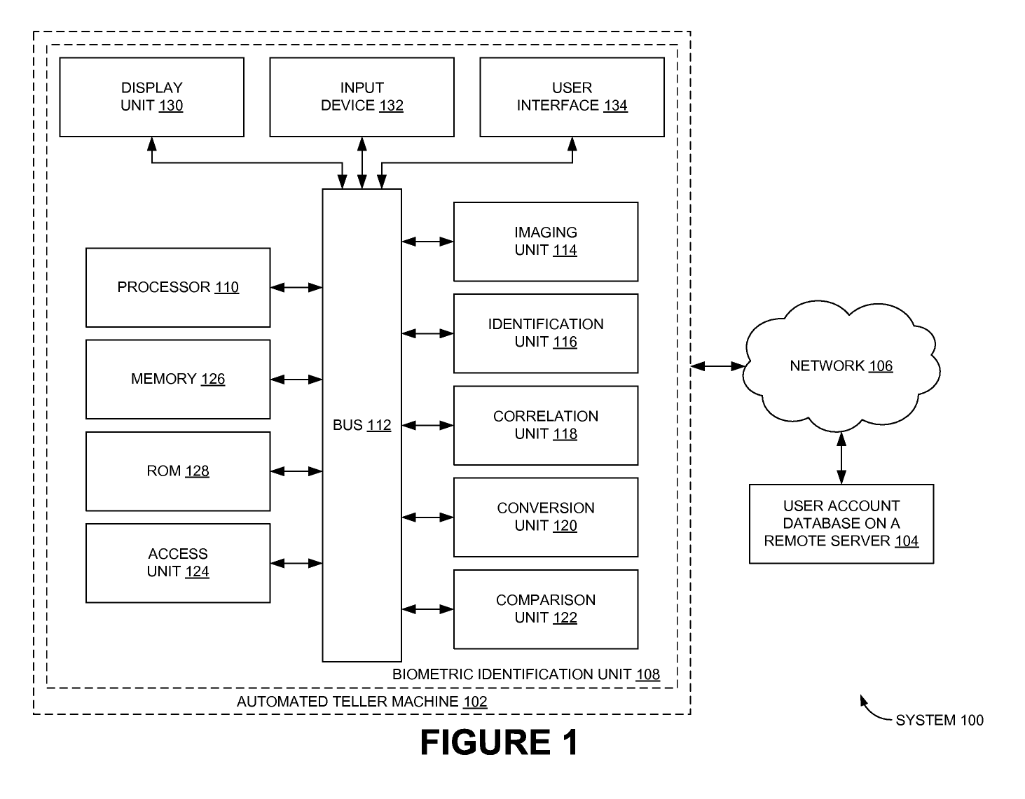

FIG. 1 illustrates a system 100 of biometric identification and authentication for financial transaction, in accordance with one or more embodiments. The system 100 includes an automated teller machine 102 in communication with a user account database 104 on a remote server through a network 106. The automated teller machine 102 is operatively coupled with a biometric identification unit 108. The biometric identification unit 108 authenticates a user based on a biometric data of the user. The biometric data of the user includes, but is not limited to structure and one or more unique identification characteristics of an iris of the user, structure and one or more unique identification characteristics of face of the user, and/or structure and one or more unique identification characteristics of fingerprint of the user. The network 106 includes, but is not limited to, a local area network, a wide area network, a wired communication network, a wireless communication network, a mobile communication network, internet, and an intranet. In one or more embodiments, the biometric identification unit 108 includes, a processor 110 operatively coupled with a bus 112. The processor 110 controls and processes various functionalities of the biometric identification unit 108. The biometric identification unit 108 also includes one or more of an imaging unit 114, an identification unit 116, a correlation unit 118, a conversion unit 120, a comparison unit 122, and an access unit 124, each operatively coupled to the bus 112. The user account database 104 includes an iris database, a face database, a fingerprint database, and a repository for storing personal information of the user performing the financial transaction. The personal information of each of the users is tagged with a biometric data template unique to each user for authentication. The biometric data template includes an iris template, a fingerprint template, and/or a face template.

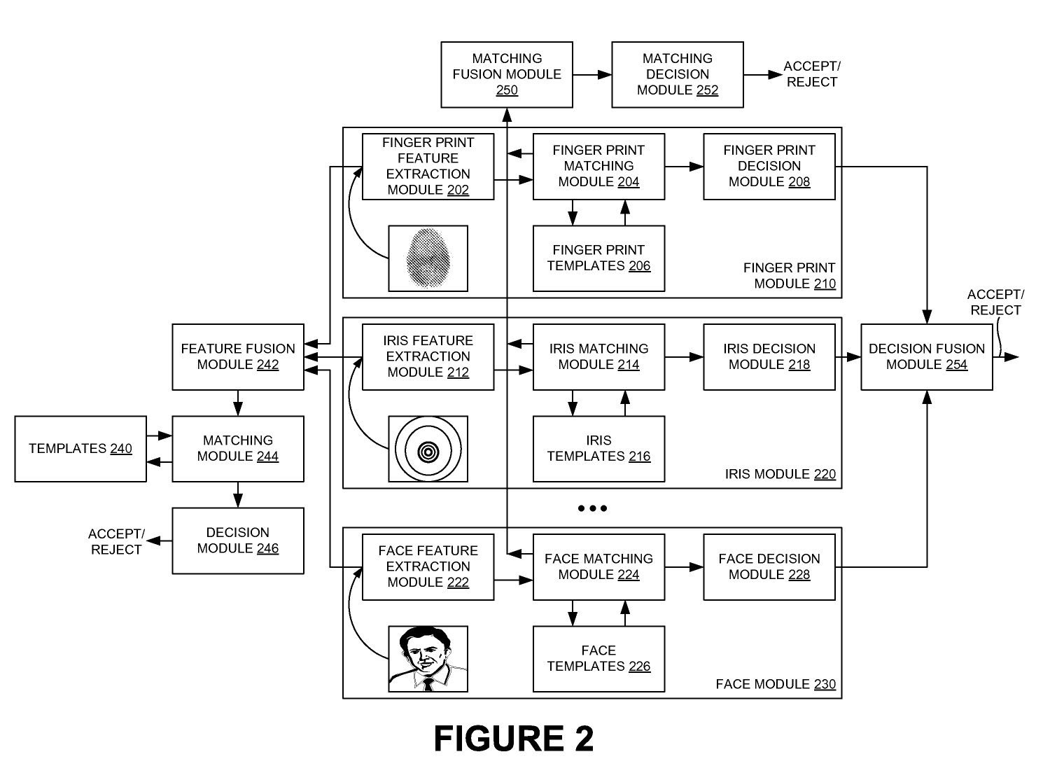

The imaging unit 114 images one or more of a face of a user, iris of the user, and fingerprint of the user through an image capturing device to obtain one or more of a digital fingerprint image, a digital iris image, and a digital face image. The digital fingerprint image, the digital iris image, and the digital face image are processed to determine a biometric data of the user of the automated teller machine 102. The image capturing device includes, but is not limited to, a digital camera, video camera, a probe, an optical device, infra-red device, a sensor, a finger print scanner, and a laser device. FIG. 2 illustrates implementation logic of the biometric identification unit 108 of the automated teller machine 102, in accordance with one or more embodiments. The biometric data includes, but is not limited to, a face data, a finger print data, and an iris data. The identification unit 116 identifies a particular instruction of a set of instructions of the automated teller machine 102 through a linguistic command data. The identification unit 116 also identifies the set of instructions to create an account of the user. The correlation unit 118 correlates name and address of the user to identify the account of the user. The correlation unit 118 also correlates a digital fingerprint image, a digital iris image, and a digital face image to the account of the user. The conversion unit 120 converts the finger print image to a digital finger print image, the iris image to a digital iris image, the face image to a digital face image to obtain the finger print data, the iris data, and the face data respectively. The comparison unit 122 compares the digital fingerprint image to a fingerprint template of the fingerprint database. The fingerprint template may include one or more digital fingerprint images, based on a fingerprint characteristic, where the fingerprint characteristic includes a ridge location of the fingerprint.

The comparison unit 122 also compares a first digital fingerprint image to a second digital fingerprint image, a first digital iris image to a second digital iris image, a first digital face image to a second digital face image to identify the user. The comparison unit 122 also compares a second digital face image to a face template of the face database. The face template includes at least one digital face image, based on a face characteristic, the face characteristic including a nose location. The comparison unit 122 also compares the second digital face image to the first digital face image based on the face characteristic to identify and authenticate the user. In one or more embodiments, the comparison unit 122 performs the above mentioned comparisons using one or more pattern recognition techniques. In one or more embodiments, pattern recognition for comparison is performed by the comparison unit 122 using one or more of artificial neural networks, Bayesian network, and/or support vector machines. The access unit 124 controls access to the account based on whether the second digital fingerprint image and the first digital fingerprint image are the same, the second digital iris image and the first digital iris image are the same, and the second digital face image and the first digital face image are the same to increase a confidence of an identification of the user.

Further, the biometric identification unit 108 also includes a memory 126 such as a random access memory (RAM) or other dynamic storage device, coupled to the bus 112 for storing information which can be used by the processor 110. The memory 126 can be used for storing any temporary information required, for example, the iris data, the finger print data and the face data. The biometric identification unit 108 further includes a read only memory (ROM) 128 or other static storage device coupled to the bus 112 for storing static information for the processor 110. The biometric identification unit 108 can be coupled via the bus 112 to a display unit 130, such as a cathode ray tube (CRT), a liquid crystal display (LCD) or a light emitting diode (LED) display, for rendering the display images to one or more users. An input device 132 including alphanumeric and other keys, may be coupled to the bus 112 for communicating an input to the processor 110. The input device 132 can be included in the biometric identification unit 108.

Another type of input device 132 may be a cursor control, such as a mouse, a trackball, a fingerprint scanner, an iris scanner, a face scanner, or cursor direction keys for communicating the input to the processor 110 and for controlling cursor movement on the display unit 130. The input device 132 can also be included in the display unit 130, for example a touch screen. In some embodiments the biometric identification unit 108 may coupled via the bus 112 to a user interface 134. The user interface 134 can include a graphical user interface, and/or a touch interface.

FIG. 2 is a system view illustrating implementation details of a biometric system associated with the ATM 102 of FIG. 1, in accordance with one or more embodiments. In particular, FIG. 2 illustrates a fingerprint module 210, an iris module 220, a face module 230, templates 240, a matching fusion module 250, and a matching decision module 252, according to one embodiment. The fingerprint module 210, the iris module 220 and the face module 230 may be a part of the imaging module 114 of FIG. 1. A biometric system may operate in the different modes including a registration mode, an identification mode and a verification mode. The registration mode or enrollment process may be a mode in which the ATM 102 may register a user as a consumer, if the user does not have any account with a bank. The identification mode may be a one to many comparisons of the captured biometric against a biometric database (e.g., located in remote server) in attempt to identify an unknown individual using the biometric identification unit 108. The verification mode may be a one to one comparison of a captured biometric with a stored template to verify that the individual is who the individual claims to be. It may be done in conjunction with a smart card, username or ID number. The biometric identification unit 108 may succeed in identifying the individual if the comparison of the biometric sample to a template in the database falls within a previously set threshold. The example embodiment illustrates a use of fingerprint authentication, iris authentication and facial detection as biometrics for authentication process.

In one or more embodiments, the template (e.g., that includes physiology features of an individual) may be obtained by the biometric system through a database module provided thereof. However, if an individual is using the system for the first time, the user features may be captured and stored in a form of templates 240 in the database module in a process called enrollment (e.g., in registration mode). In one or more embodiments, the enrollment process may be performed using appropriate input devices such as the imaging unit 114. The templates 240 may be used for authentication process for future transactions. Fingerprint recognition and the fingerprint authentication may be performed using an automated process for verifying a match (or through comparison) between two human fingerprints. Fingerprints may be one of many forms of biometrics used to identify an individual and verify their identity. In one or more embodiments, the system may include fingerprint module 210 for processing a fingerprint data. The fingerprint module 210, inter alia, may include other modules for processing a fingerprint data such as a fingerprint feature extraction module 202, fingerprint matching module 204, and fingerprint decision module 208. The fingerprint module 210 may also include a finger print extraction sensor for extracting a fingerprint feature (e.g., through the imaging unit 114). The fingerprint sensor may be an electronic device used to capture a digital image of the fingerprint pattern. In one or more embodiments, the fingerprint feature extraction module 202 may extract the fingerprint of an individual through the fingerprint sensor. Also, in one or more embodiments, the fingerprint may be captured as an image. The captured image may be called a live scan image. The live scan image may be digitally processed (e.g., using the conversion unit 120 of FIG. 1) to create a biometric template (a collection of extracted features) by the fingerprint feature extraction module 202. The biometric template may be stored in fingerprint templates 206 and in a fingerprint database (of the database module).

The stored biometric template specific to an individual may be used for matching (or through comparison) during authentication. The fingerprint matching module 204 (a part of the comparison unit 122 of FIG. 1) may match the current fingerprint with the fingerprint template stored in the fingerprint database (through comparison). The fingerprint decision module 208 may generate a decision based on an output generated by the fingerprint matching module 204. Some of the fingerprint scanning technologies may include, but not limited to optical fingerprint imaging, use of ultrasonic sensors and capacitance sensors for scanning fingerprints. The optical fingerprint imaging involves capturing a digital image of the print using visible light. In one or more embodiments, this type of sensor is, in essence, a specialized digital camera. The top layer of the sensor, where the finger may be placed, is known as the touch surface. Beneath this layer is a light-emitting phosphor layer which illuminates the surface of the finger. The light reflected from the finger passes through the phosphor layer to an array of solid state pixels (a charge-coupled device) which captures a visual image of the fingerprint.

The ultrasonic sensors make use of the principles of medical ultrasonography in order to create visual images of the fingerprint. The ultrasonic sensors may use very high frequency sound waves to penetrate the epidermal layer of skin. The sound waves may be generated using piezoelectric transducers and reflected energy is also measured using piezoelectric materials. Since the dermal skin layer exhibits the same characteristic pattern of the fingerprint, the reflected wave measurements can be used to form an image of the fingerprint. The capacitance sensors utilize the principles associated with capacitance in order to form fingerprint images. In one or more embodiments, in this method of imaging, the sensor array pixels may each act as one plate of a parallel-plate capacitor, the dermal layer (which is electrically conductive) acts as the other plate, and the non-conductive epidermal layer acts as a dielectric. A passive capacitance sensor may use the principle outlined above to form an image of the fingerprint patterns on the dermal layer of skin. Each sensor pixel may be used to measure the capacitance at that point of the array. The capacitance varies between the ridges and valleys of the fingerprint due to the fact that the volume between the dermal layer and sensing element in valleys contains an air gap. The dielectric constant of the epidermis and the area of the sensing element are known values. The measured capacitance values are then used to distinguish between fingerprint ridges and valleys.

Active capacitance sensors may use a charging cycle to apply a voltage to the skin before measurement takes place. The application of voltage charges the effective capacitor. The electric field between the finger and sensor follows the pattern of the ridges in the dermal skin layer. On the discharge cycle, the voltage across the dermal layer and sensing element is compared against a reference voltage in order to calculate the capacitance. The distance values are then calculated mathematically and used to form an image of the fingerprint. Active capacitance sensors measure the ridge patterns of the dermal layer like the ultrasonic method. Iris recognition is a method of biometric authentication that uses pattern recognition techniques based on high-resolution images of the iris of an individual's eyes.

According to one embodiment, the system may include the iris module 220 for processing iris data for authentication. The iris module 220 may include, inter alia, may include other modules for processing an iris data such as an iris feature extraction module 212, an iris matching module 214, and an iris decision module 218. In addition, the iris module 220 may include an iris sensor for recognition of iris. In one or more embodiments, the iris recognition may use camera technology, with subtle infrared illumination reducing specular reflection from the convex cornea, to create images of the detail-rich, intricate structures of the iris. The created images may be converted into digital templates and stored in the iris templates 216 and an iris database of the database module. The digital templates include iris images that provide mathematical representations of the iris that yield unambiguous positive identification of an individual. In addition, the iris module 220 may use an iris recognition algorithm in the iris matching module 214. The iris-recognition algorithm may identify the approximately concentric circular outer boundaries of the iris and the pupil in a photo of an eye. The set of pixels covering only the iris is then transformed into a bit pattern that preserves the information that is used for a statistically meaningful comparison between two iris images. The mathematical methods used resemble those of modern lossy compression algorithms for photographic images. Other algorithms may be used as well by the iris module 220 not limited to the iris recognition algorithm.

To authenticate via identification (one-to-many template matching) or verification (one-to-one template matching), the template created by imaging the iris may be compared using the iris matching module 214 with a stored value template in the iris database of the database module. The iris decision module 218 may generate a decision signal based on an output generated by the iris matching module 214.

Similarly, the face module 230 may be used for capturing images of a face and processing the pixels into templates that may be stored in the face templates 226 and the face database (of the database module). The face module 230 may implement a facial recognition system to perform facial recognition and processing. The facial recognition system may be an application for automatically identifying or verifying a person from a digital image or a video frame from a video source. One of a method to perform the facial recognition is by comparing selected facial features from the image with a stored value template associated with the user from facial templates 226. The facial recognition system may be used in security systems and can be compared to other biometrics such as fingerprint or eye iris recognition systems. In one or more embodiments, an image capturing device (e.g., a part of the imaging unit 114 of FIG. 1) such as a camera may be used for capturing images of face. The face data may be compared with the existing templates stored using the face matching module 224 and decision may be generated by a face decision module 228.

The matching process of all features obtained from the fingerprint module 210, the iris module 220, the face module 230, etc. may be performed in matching module 244 (e.g., through comparison). The templates 240 backed by the database module may provide one or more pre-stored templates or one or more feature template to enable the matching modules (e.g., the fingerprint matching module 204, the iris matching module 214, the face matching module 224) for matching process. In one or more embodiments, a feature fusion module 242 may interlink one or more physiological features templates generated from the fingerprint feature extraction module 202, the iris feature extraction module 212, the face feature extraction module 222, etc. A decision module 246 may generate a decision to authenticate (e.g., accept/reject) the individual's request based on the input obtained from the matching module 244. In addition, the matching fusion module 250 may obtain input from the fingerprint matching module 204, the iris matching module 214, and the face matching module 224 and combines one or more matching responses from the aforementioned modules. The matching decision module 252 may authenticate (e.g., accept or reject) a customer based on the input obtained from the matching fusion module 250. Furthermore, the system also includes a decision fusion module 254 that obtains input data from the fingerprint decision module 208, the iris decision module 218, the face decision module 228, etc. to combine the decisions to authenticate the user based on decisions obtained from one or more of data processing modules (e.g., the fingerprint module 210, the iris module 220 and the face module 230).

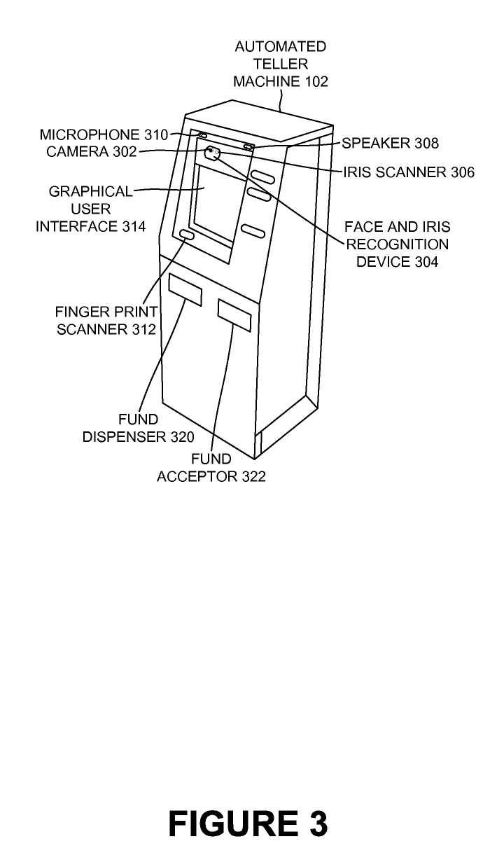

FIG. 3 is a perspective view of an automated teller machine 102 enabled with a biometric identification unit 108, in accordance with an example embodiment. In this embodiment, the automated teller machine 102 includes a camera 302, a face and iris recognition device 304, an iris scanner 306, a speaker 308, a microphone 310, a fingerprint scanner 312 and a graphical user interface 314 as input devices. In one or more embodiments, the face and iris recognition device 304 may include the camera 302 and the iris scanner 306 to scan the face and the iris of the user simultaneously. Alternatively, the camera 302 and the iris scanner 306 may be provided separately for scanning at different instants of time. The user may provide identity to the automated teller machine 102 by appearing in front of the camera for facial detection or appearing in front of an iris scanner 306 for iris scanning or providing finger to the fingerprint scanner 312, or using a microphone 310 for communicating through voice.

Alternatively, the automated teller machine 102 may automatically detect the presence of the user by detecting a face of the user using the camera 302, detecting sound through microphone 310, or detecting a fingerprint in the fingerprint scanner 312. In one or more embodiments, the automated teller machine 102 may guide the user visually through the user interface 134, or through voice using the speaker 308. In one or more embodiments, the user may respond or provide input to the biometric identification unit 108 using any of the input devices described herein. Also, in one or more embodiments, the user may be able to manually provide input through the graphical user interface 314, voice, or through any of the input devices. In addition, the automated teller machine 102 may also include a fund dispenser 320 to provide funds and a fund acceptor 322 to accept funds.

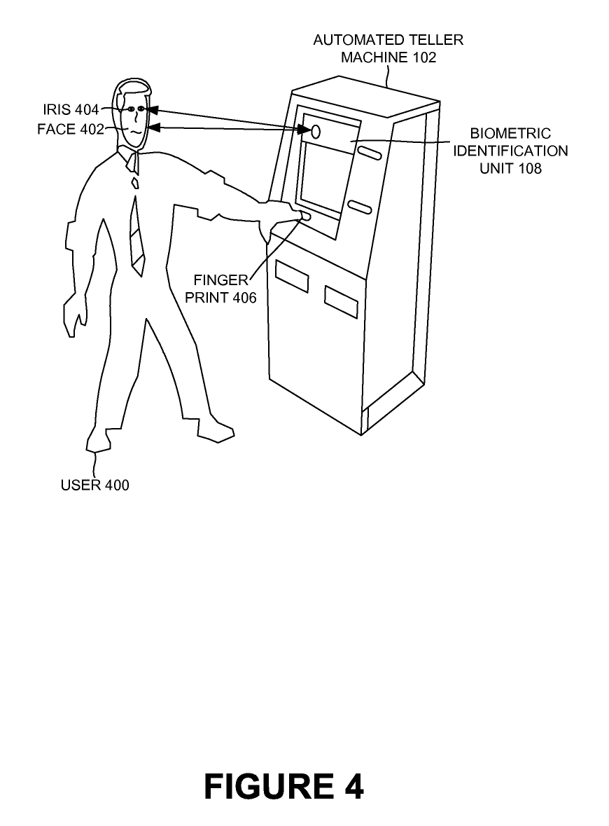

FIG. 4 illustrates a schematic view of a user 400 using an automated teller machine 102 enabled with a biometric identification unit 108 for a financial transaction, in accordance with to one or more embodiments. According to one embodiment, the user 400 need not carry any credit cards, etc. for performing transactions. The physiological features such as face, fingerprints, the iris, etc. may be used for identifying, authenticating and/or billing the user 400. The biometric identification unit 108 may include one or more biometric sensors for performing authentication. In an example embodiment, the biometric identification unit 108, may include but is not limited to an iris scanner, a camera, and a finger print scanner. The authentication process may be performed using any of the physiological features or all of features based on security requirement provided by an institution. In an example embodiment, the biometric identification unit 108 may obtain an iris 402 data, a face 404 data, a fingerprint 406 data for performing authentication. The automated teller machine 102 may enable transactions on authentication.

In one or more embodiments, when the user 400 uses biometric identification unit 108 for a first time, the biometric identification unit 108 may initiate an enrollment process. During the enrollment process, biometric information from the user 400 is stored. In subsequent uses, biometric information is detected and compared with the information stored at a time of enrollment. Storage and retrieval of biometric information may be secure. In one or more embodiments, the biometric identification unit 108 may enable a new user to open a new account through the automated teller machine 102. The automated teller machine 102 may provide a user interface for providing data and may also collect user physiological information such as iris data, fingerprint from the new user as an identity data of the new user. In addition, the automated teller machine 102 may guide the user step by step to enable the user to create a new account and for performing financial transactions. The automated teller machine 102 may also provide guidance through voice, visual representations through, for example, the users interface to enable an easy process for opening the new account or for performing financial transactions.

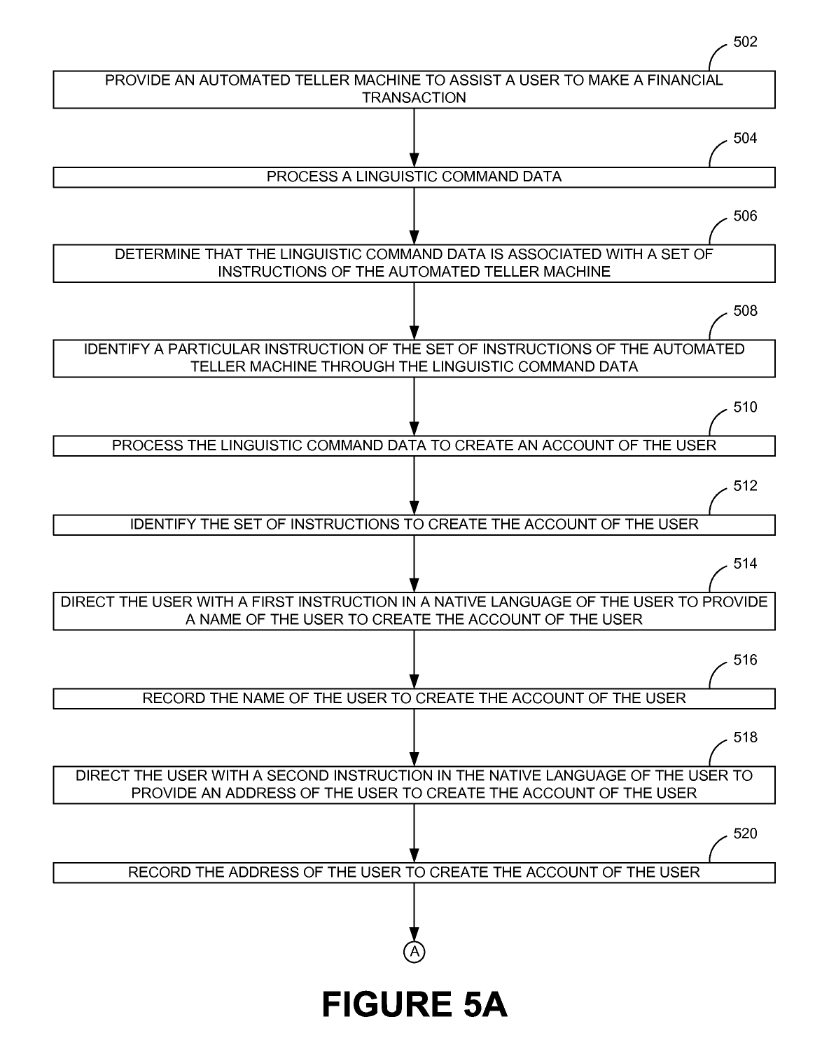

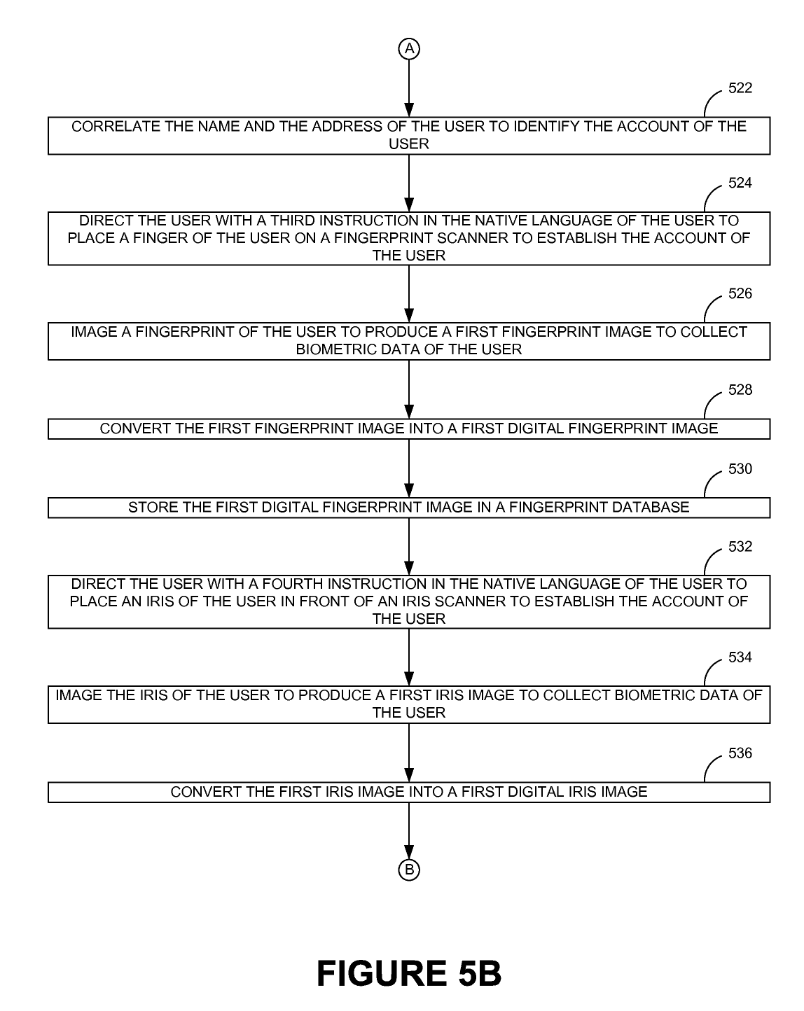

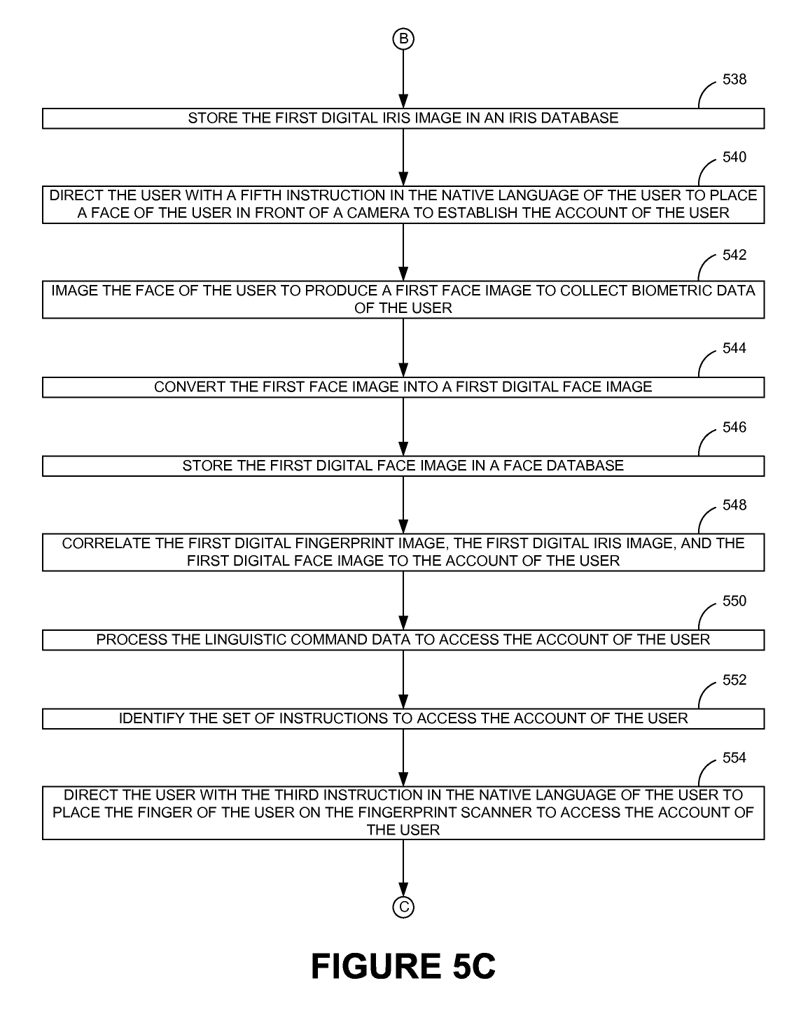

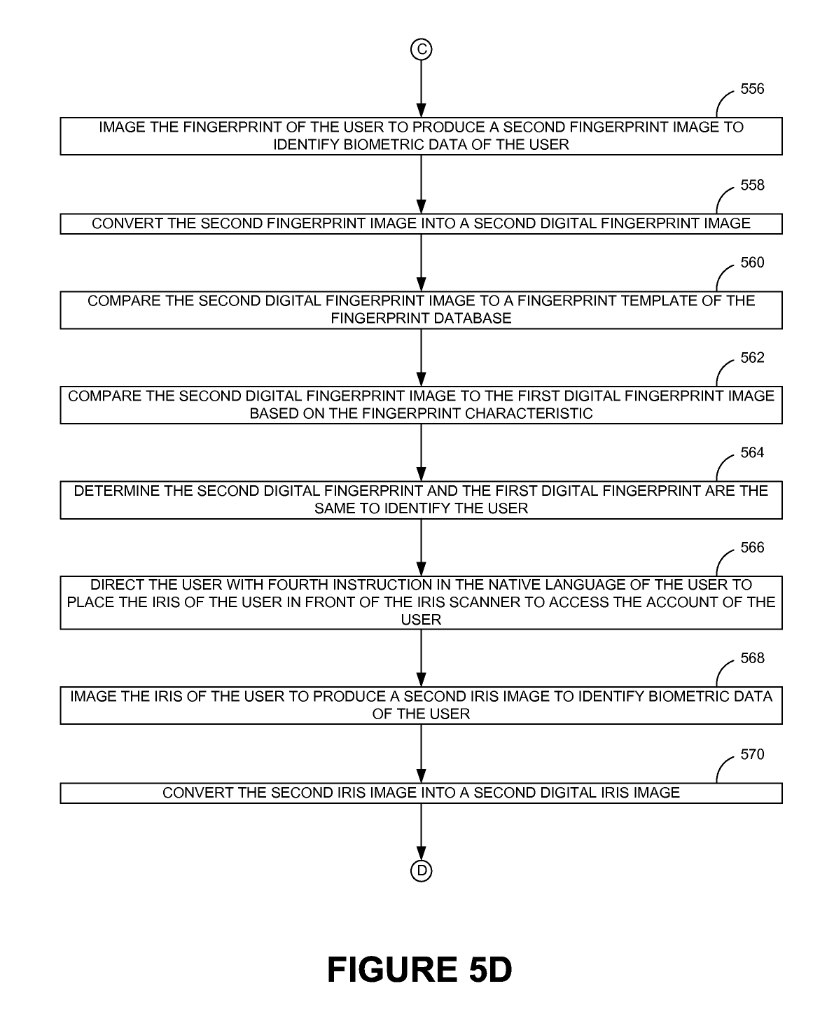

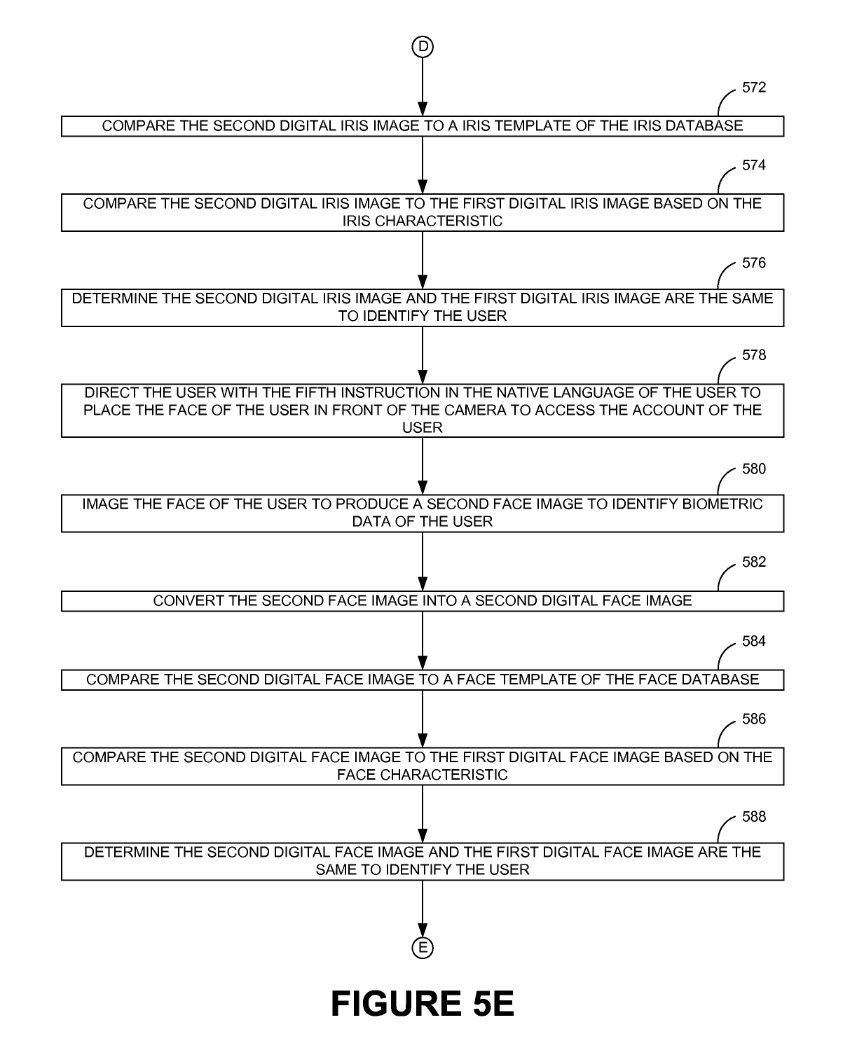

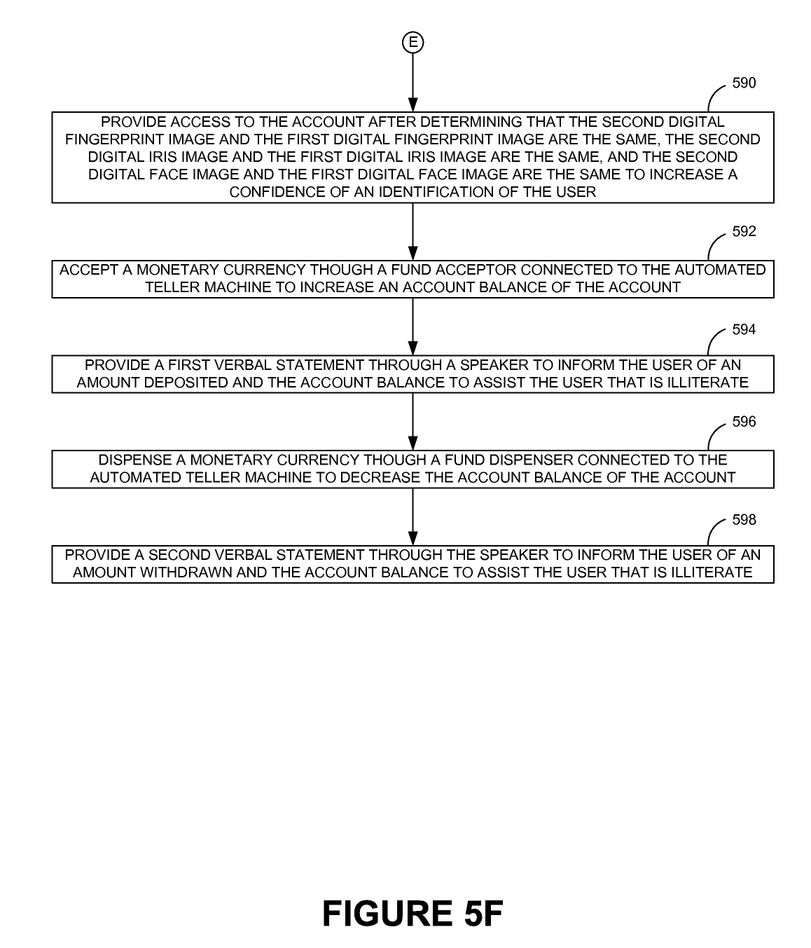

FIGS. 5A-5F is a process flow illustrating method of biometric identification and authentication for financial transactions, in accordance with one or more embodiments. In one or more embodiments, in operation 502, an automated teller machine may be provided to assist a user to make a financial transaction. In one or more embodiments, in operation 504 a linguistic command data may be processed. In one or more embodiments, in operation 506, the linguistic command data associated with a set of instructions of the automated teller machine may be determined. In one or more embodiments, in operation 508, a particular instruction of the set of instructions of the automated teller machine may be provided through the linguistic command data. In one or more embodiments, in operation 510, the linguistic command data may be processed to create an account of the user. In one or more embodiments, in operation 512, the set of instructions may be identified to create the account of the user. In one or more embodiments, in operation 514, the user may be directed with a first instruction in a native language of the user to provide a name of the user to create the account of the user.

In one or more embodiments, in operation 516, the name of the user may be recorded to create the account of the user. In one or more embodiments, in operation 518, the user may be directed with a second instruction in the native language of the user to provide an address of the user to create an account of the user. In one or more embodiments, in operation 520, the address of the user may be recorded to create the account of the user. In one or more embodiments, in operation 522, the name and the address of the user may be correlated to identify the account of the user. In one or more embodiments, in operation 524, the user may be directed with a third instruction in the native language of the user to place a finger of the user on a fingerprint scanner to establish the account of the user. In one or more embodiments, in operation 526, the fingerprint of the user may be imaged to produce a first fingerprint image to collect a biometric data of the user. The biometric data of the user includes, but is not limited to structure and one or more unique identification characteristics of an iris of the user, structure and one or more unique identification characteristics of face of the user, and/or structure and one or more unique identification characteristics of fingerprint of the user. In one or more embodiments, in operation 528, the first fingerprint image may be converted into a first digital fingerprint image. In one or more embodiments, in operation 530, the first digital fingerprint image may be stored in a fingerprint database.

In one or more embodiments, in operation 532, the user may be directed with a fourth instruction in the native language of the user to place an iris of the user in front of an iris scanner to establish the account of the user. In one or more embodiments, in operation 534, the iris of the user may be imaged to produce a first iris image to collect biometric data of the user. In one or more embodiments, in operation 536, the first iris image may be converted into a first digital iris image. In one or more embodiments, in operation 538, the first digital iris image may be stored in an iris database. In one or more embodiments, in operation 540, the user may be directed with a fifth instruction in the native language of the user to place a face of the user in front of a camera to establish the account of the user.

In one or more embodiments, in operation 542, the face of the user may be imaged to produce a first face image to collect biometric data of the user. In one or more embodiments, in operation 544, the first face image may be converted into a first digital face image. In one or more embodiments, in operation 546, the first digital face image may be stored in a face database. In one or more embodiments, in operation 548, the first digital fingerprint image may be correlated, the first digital iris image, and the first digital face image to the account of the user. In one or more embodiments, in operation 550, the linguistic command data may be processed to access the account of the user. In one or more embodiments, in operation 552, the set of instructions may be identified to access the account of the user. In one or more embodiments, in operation 554, the user may be directed with the third instruction in the native language of the user to place the finger of the user on the fingerprint scanner to access the account of the user.

In one or more embodiments, in operation 556, the fingerprint of the user may be imaged to produce a second fingerprint image to identify biometric data of the user. In one or more embodiments, in operation 558, the second fingerprint image may be converted into a second digital fingerprint image. In one or more embodiments, in operation 560, the second digital fingerprint image may be compared to a fingerprint template of the fingerprint database. The fingerprint template includes, but is not limited to at least one digital fingerprint image based on a fingerprint characteristic. The fingerprint characteristic includes, but is not limited to a ridge location of the fingerprint. In one or more embodiments, in operation 562, the second digital fingerprint image may be compared to the first digital fingerprint image based on the fingerprint characteristic. In one or more embodiments, the comparisons may be performed using one or more pattern recognition techniques. In one or more embodiments, pattern recognition for comparison may be performed using one or more of artificial neural networks, Bayesian network, and/or support vector machines.

In one or more embodiments, in operation 564, it may be determined if the second digital fingerprint and the first digital fingerprint are the same to identify the user. In one or more embodiments, in operation 566, the user may be directed with fourth instruction in the native language of the user to place the iris of the user in front of the iris scanner to access the account of the user. In one or more embodiments, in operation 568, the iris of the user may be imaged to produce a second iris image to identify biometric data of the user. In one or more embodiments, in operation 570, the second iris image may be converted into a second digital iris image. In one or more embodiments, in operation 572, the second digital iris image may be converted to an iris template of the iris database, wherein the iris template comprises at least one digital iris image, based on an iris characteristic. The iris characteristic includes a pigmentation of the iris.

In one or more embodiments, in operation 574, the second digital iris image may be compared to the first digital iris image based on the iris characteristic. In one or more embodiments, in operation 576, it may be determined if the second digital iris image and the first digital iris image are the same to identify the user. In one or more embodiments, in operation 578, the user may be directed with the fifth instruction in the native language of the user to place the face of the user in front of the camera to access the account of the user. In one or more embodiments, in operation 580, the face of the user may be imaged to produce a second face image to identify biometric data of the user. In one or more embodiments, in operation 582, the second face image may be converted into a second digital face image. In one or more embodiments, in operation 584, the second digital face image may be compared to a face template of the face database.

The face template includes at least one digital face image, based on a face characteristic. The face characteristic includes, but is not limited to a nose location. In one or more embodiments, in operation 586, the second digital face image may be compared to the first digital face image based on the face characteristic. In one or more embodiments, in operation 588, it may be determined if the second digital face image and the first digital face image are the same to identify the user. In one or more embodiments, in operation 590, an access to the account may be provided after determining that the second digital fingerprint image and the first digital fingerprint image are the same, the second digital iris image and the first digital iris image are the same, and/or the second digital face image and the first digital face image are the same to increase the confidence of an identification of the user.

In one or more embodiments, in operation 592, a monetary currency may be accepted though a fund acceptor connected to the automated teller machine to increase an account balance of the account. In one or more embodiments, in operation 594, a first verbal statement may be provided through the speaker to inform the user of an amount deposited and the account balance to assist the user that may be illiterate. In one or more embodiments, in operation 596, a monetary currency may be dispensed though a fund dispenser connected to the automated teller machine to decrease the account balance of the account. In one or more embodiments, in operation 598, a second verbal statement may be provided through the speaker to inform the user of an amount withdrawn and the account balance to assist the user that may be illiterate.

In one or more embodiments, a secondary authentication of the user may be requested when at least one of a biometric pattern and a voice pattern may be unrecognizable. In one or more embodiments, a human service personnel associated with at least one of the automated teller machine and a banking system may be notified to manually authenticate the user when the at least one of the biometric pattern and the voice pattern may be unrecognizable. The user of a banking system accessible through the automated teller machine may be authenticated by analyzing at least one of a biometric pattern and a voice pattern uniquely associated with the user. Further, an access may be provided to a financial account of the banking system associated with the user based on the authentication.

In one or more embodiments the set of instructions to authenticate the account of the user may be identified to create the account of the user with a personal identification number when at least one of a biometric pattern and a voice pattern may be unrecognizable. The user may be directed with a sixth instruction in the native language of the user to provide the personal identification number to authenticate the account of the user. The personal identification number may be recorded to authenticate the account of the user. An access to the financial account of the banking system associated with the user may be provided based on the authentication.

The embodiments described herein may be used for providing banking services at ATMs without a requirement of any identification material that include passbook, debit/credit cards, etc. In addition, the embodiments described herein may enable an illiterate user to perform transactions associated with a financial account of the illiterate user. In addition, even a non user (e.g., non-customer) may be enabled to create and manage accounts through an ATM, in contrast to creating an account manually in a bank office. Furthermore, the embodiments described herein may enable a section of users who do not use ATM to use ATM services efficiently. Furthermore, the embodiments described herein may empower and optimize the already existing ATMs.

Although the present embodiments have been described with reference to specific example embodiments, it will be evident that various modifications and changes may be made to these embodiments without departing from the broader spirit and scope of the various embodiments. Accordingly, the specification and drawings are to be regarded in an illustrative rather than a restrictive sense.

What is claimed:

1. A method of biometric identification comprising:
providing an automated teller machine to assist a user to make a financial transaction;
processing a linguistic command data;
determining that the linguistic command data is associated with a set of instructions of the automated teller machine;
identifying a particular instruction of the set of instructions of the automated teller machine through the linguistic command data;
processing the linguistic command data to create an account of the user;
identifying the set of instructions to create the account of the user;
directing the user with a first instruction in a native language of the user to provide a name of the user to create the account of the user;
recording the name of the user to create the account of the user;
directing the user with a second instruction in the native language of the user to provide an address of the user to create the account of the user;
recording the address of the user to create the account of the user;
correlating the name and the address of the user to identify the account of the user;
directing the user with a third instruction in the native language of the user to place a finger of the user on a fingerprint scanner to establish the account of the user;
imaging a fingerprint of the user to produce a first fingerprint image to collect biometric data of the user;
converting the first fingerprint image into a first digital fingerprint image;
storing the first digital fingerprint image in a fingerprint database;
directing the user with a fourth instruction in the native language of the user to place an iris of the user in front of an iris scanner to establish the account of the user;
imaging the iris of the user to produce a first iris image to collect biometric data of the user;
converting the first iris image into a first digital iris image;
storing the first digital iris image in an iris database;
directing the user with a fifth instruction in the native language of the user to place a face of the user in front of a camera to establish the account of the user;
imaging the face of the user to produce a first face image to collect biometric data of the user;
converting the first face image into a first digital face image;
storing the first digital face image in a face database;
correlating the first digital fingerprint image, the first digital iris image, and the first digital face image to the account of the user;
processing the linguistic command data to access the account of the user;
identifying the set of instructions to access the account of the user;
directing the user with the third instruction in the native language of the user to place the finger of the user on the fingerprint scanner to access the account of the user;
imaging the fingerprint of the user to produce a second fingerprint image to identify biometric data of the user;
converting the second fingerprint image into a second digital fingerprint image;
comparing the second digital fingerprint image to a fingerprint template of the fingerprint database, wherein the fingerprint template comprises at least one digital fingerprint image, based on a fingerprint characteristic, wherein the fingerprint characteristic comprises a ridge location of the fingerprint;
comparing the second digital fingerprint image to the first digital fingerprint image based on the fingerprint characteristic;
determining the second digital fingerprint and the first digital fingerprint are the same to identify the user;
directing the user with fourth instruction in the native language of the user to place the iris of the user in front of the iris scanner to access the account of the user;
imaging the iris of the user to produce a second iris image to identify biometric data of the user;
converting the second iris image into a second digital iris image;
comparing the second digital iris image to a iris template of the iris database, wherein the iris template comprises at least one digital iris image, based on an iris characteristic, wherein the iris characteristic comprises a pigmentation of the iris;
comparing the second digital iris image to the first digital iris image based on the iris characteristic;
determining the second digital iris image and the first digital iris image are the same to identify the user;
directing the user with the fifth instruction in the native language of the user to place the face of the user in front of the camera to access the account of the user;
imaging the face of the user to produce a second face image to identify biometric data of the user;
converting the second face image into a second digital face image;
comparing the second digital face image to a face template of the face database, wherein the face template comprises at least one digital face image, based on a face characteristic, wherein the face characteristic comprises a nose location;
comparing the second digital face image to the first digital face image based on the face characteristic;
determining the second digital face image and the first digital face image are the same to identify the user;
providing access to the account after determining that the second digital fingerprint image and the first digital fingerprint image are the same, the second digital iris image and the first digital iris image are the same, and the second digital face image and the first digital face image are the same to increase a confidence of an identification of the user;
accepting a monetary currency though a fund acceptor connected to the automated teller machine to increase an account balance of the account;
providing a first verbal statement through a speaker to inform the user of an amount deposited and the account balance to assist the user that is illiterate;
dispensing a monetary currency though a fund dispenser connected to the automated teller machine to decrease the account balance of the account; and
providing a second verbal statement through the speaker to inform the user of an amount withdrawn and the account balance to assist the user that is illiterate.

2. The method of claim 1, further comprising: requesting a secondary authentication of the user when at least one of a biometric pattern and a voice pattern is unrecognizable.

3. The method of claim 2, further comprising:
notifying a human service personnel associated with at least one of the automated teller machine and a banking system to manually authenticate the user when the at least one of the biometric pattern and the voice pattern is unrecognizable.
authenticating a user of a banking system accessible through the automated teller machine by analyzing at least one of a biometric pattern and a voice pattern uniquely associated with the user; and
providing access to a financial account of the banking system associated with the user based on the authentication.

4. The method of claim 3 further comprising:
identifying the set of instructions to authenticate the account of the user create the account of the user with a personal identification number when at least one of a biometric pattern and a voice pattern is unrecognizable;
directing the user with a sixth instruction in the native language of the user to provide the personal identification number to authenticate the account of the user;
recording the personal identification number to authenticate the account of the user; and
providing access to the financial account of the banking system associated with the user based on the authentication.
